(19) United States
(12) Patent Application Publication
(10) Pub. No.: US 2008/0033843 A1
(43) Pub. Date: Feb. 7, 2008

(54) Product specification system

(75) Inventors: Thomas Warton, Sonoma, CA (US); Scott S. Yu, San Francisco, CA (US)

Correspondence Address: PETER JAMES TORMEY, 2017 ESPERANZA DRIVE, CONCORD, CA, 94519, US

(73) Assignee: Vode LLC, Sonoma, CA (US)

(21) Appl. No.: 11/890,064

(22) Filed: Aug. 3, 2007

Related U.S. Application Data
(60) Provisional application No. 60/835,664, filed on Aug. 4, 2006.

(51) Int. Cl. G06F 17/30

(52) U.S. Cl. 705/27

(57) ABSTRACT

A computer implemented commerce system comprising at least one user interfaces for providing an image of a product design; said user interface presenting at least one menu of conforming elements; said user interface displaying at least one configuration code that relates to the product design; a processor unit communicably coupled to the user interface and to a memory module for storage of processor instructions; and one or more databases communicably coupled to the processor, wherein the processor controls the user interface for providing the menu of conforming elements such that the user iteratively selects one or more conforming elements to effectuate the product design and the processor controls the user interface to present the configuration code and the image of the product design.

This application claims the benefit of U.S. Patent Application 60/835,664 “Configurator for product specification” filed on Aug. 4, 2006 which is incorporated herein by reference.

### BACKGROUND

Modern product design is often geared towards providing attractive products for commercial applications such as lighting fixtures or luminaires. The design of a luminaire must allow for certain functional requirements such as safety, light output, ease of installation and affordability without sacrificing the attractive elements of a luminaire. Consequently there are many variables for both designers and manufacturers to consider to properly provide lighting fixtures in an industrial setting. Conventionally light manufacturers provide a variety of parts which must be coordinated to realize a specific design. Some of the drawbacks to this method are the inability to visualize a final design and a decreased ability to assure all require parts are ordered and sent to a job site. This problem may be exacerbated because of traditional sales channels and industry usage.

Besides the supply chain problems noted above, complex series of parts may also require a set of complex specifications, and those specifications need to be delivered to many different entities. For example if a customer wanted to order custom furniture from an office furniture company, they may simply choose to order a desk of a specific size with matching cabinetry. In actuality, the desk of a specific size and the matching cabinetry may be comprised of many different components (i.e. legs, drawers, etc . . . ) such that it would be difficult for a customer to determine all the parts needed to order the desk and cabinetry without following detailed instruction. In another example, lighting fixtures may be specified by a designer and those fixtures may include many different parts and subassemblies. Once specified by a designer, they may be purchased by a separate party (a customer) for delivery to a building contractor where they are eventually inspected by a government agent to ensure compliance with their original specifications. All of these steps occurring over an extended period of time. Other examples of these types of complex ordering procedures can be found in other industries including, but not limited to office furniture, fire safety systems and large scale manufacturing systems.

Electronic commerce or e-commerce includes the transfer of orders, sales communications, credit information, electronic “funds”, and digital products throughout a supply chain. In some industries such as construction and custom manufacturing, there is a long lead time between when a part (or series of parts) is specified and the time the purchase order for the parts is placed. There may also be a long time between when the purchase order is placed and when the parts are supplied or installed. Oftentimes the part or product ordered consists of a series of differing parts and the configuration may not be easily apparent to a customer. The series of parts may also need alterations during any time delay due to newly realized design considerations, new government regulations or from improved manufacturing processes.

If view of the foregoing there is a need for a system and method that allows for visually creating a product design or specifying unique parts and services and then ordering and tracking the product design through the manufacturing process while keeping the various parties informed about the exact nature and specification of the design.

### SUMMARY

Disclosed herein is a computer implemented commerce system comprising at least one user interfaces for providing an image of a product design; said user interface presenting at least one menu of conforming elements; said user interface displaying at least one configuration code that relates to the product design; a processor unit communicably coupled to the user interface and to a memory module for storage of processor instructions; and one or more databases communicably coupled to the processor, wherein the processor controls the user interface for providing the menu of conforming elements such that the user iteratively selects one or more conforming elements to effectuate the product design and the processor controls the user interface to present the configuration code and the image of the product design.

### BRIEF DESCRIPTION OF THE DRAWINGS

FIG. 1 illustrates a portion of a flowchart for certain aspects according to the current disclosure.

FIG. 2 shows one embodiment according to the current disclosure.

FIG. 3 shows one aspect of the current invention where a user can access the system and determine pricing.

FIG. 4 shows one possible user interface according the current disclosure.

FIG. 5 shows the menu aspect of certain aspects of the invention.

FIG. 6 is a representative sample of a specification sheet one would see in a lighting configuration.

FIG. 7 shows yet another display according to the current disclosure.

FIG. 8 shows a customization aspect according to the current disclosure.

FIG. 9 is a detailed block diagram showing parts of other embodiments of the current invention.

Table 1 shows source code for a portion of one embodiment of one facet of the current invention.

### DETAILED DESCRIPTION AND OPERATION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Those skilled in the art will recognize that it is common within the art to describe devices and/or processes in the fashion set forth herein, and thereafter use standard engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs and one or more interaction devices, such as a touch pad or screen. A typical data processing system may be implemented utilizing many suitable commercially available components, such as those typically found in data computing/communication and/or network computing/communication systems.

One having skill in the art will also appreciate that computer-based user interfaces or displays are typically constructed of objects that provide certain functions such as the display of information or for gathering user information. Information may be displayed on a single user interface or in multiple user interfaces depending on the requirements of the computer program. Objects may be highly specialized or may be comprised of one or more specific function controls such that software developers developing object oriented programs may use several controls to effectuate a user interface or display. Also generating information to present to a user includes generating a display for a video terminal, printed information or information for electronic transmission.

The construction and method of operation of the invention, however, together with additional objectives and advantages thereof will be best understood from the following description of specific embodiments when read in connection with the accompanying drawings. Examples of products appropriate for the current disclosure include but are not limited to industrial lighting systems, lighting fixtures and furniture. For purposes of illustration the design and specification of a lighting system or a furniture system will be used in this disclosure, although the use of the disclosed system and method is not limited to the lighting or furniture systems presented herein.

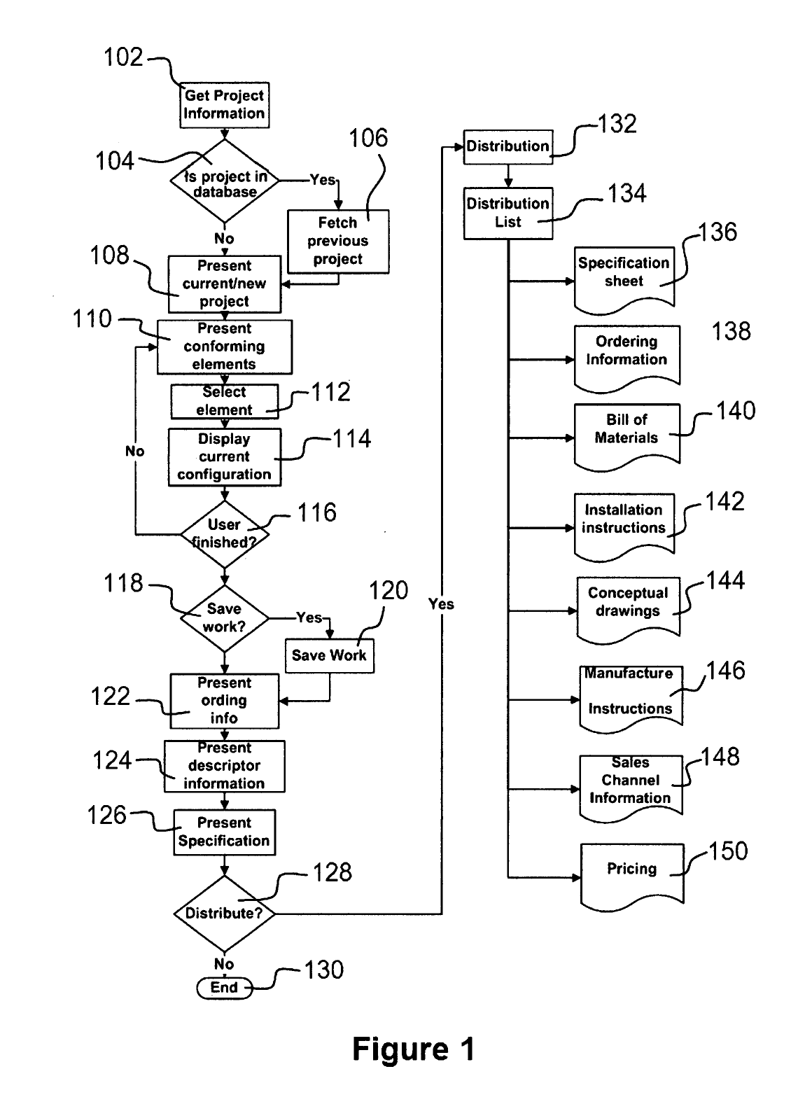

FIG. 1 illustrates a portion of a flowchart for certain aspects according to the current disclosure. In contrast to others systems wherein a user simply selects differing options for products, the current disclosure allows for designing a completely new product design through an iterative process of selecting features, visualizing the results and finally ordering the created product design from a manufacturer. The product design is the information necessary to realize the product. For example it may be comprised of a graphical representation, a unique identification number, a narrative description or a combination thereof to enable a supplier to supply the appropriate elements. Certain features are constructed of one or more elements such that if a user selects a feature, the computer constructs an image based on the required elements for that feature. Initially the designer need not know any details of the final product, but may, by choosing differing features, create a new and unique product design. Accordingly, in this example, lighting is usually specified by architects or other professionals generally known as designers. During the specification stage, different parts of a lighting system are specified to meet certain design criteria. Designers practice their art by combining different elements of a lighting system to produce a unique lighting design that meets both a practical and an aesthetic goal. The elements may be specific parts, or they may be desired features of a lighting system. For example, a designer may desire an eight foot luminaire. The system allows visualization of a split lamp with two four-foot sections or a luminaire with four two-foot sections. The system of the current disclosure would receive the product design for the lighting system and generate a bill of materials (BOM) among other things. For an 8 foot lighting system with two 4-foot housings, this BOM might include the lamps, light rails, support arms, ballast equipment and other parts needed to employ the desired design. For other applications, office furniture for example, the designer may select two 8-foot desks with different drawers and support structures. The system would generate a BOM with all the required drawers, legs, supports, panels and other parts required to properly build, ship and install the office furniture. The system of the current disclosure may also generate pricing information, installation instructions, specification sheets, ordering information, electrical drawings, conceptual drawings, manufacturing instructions, electrical drawings, and sales channel information as well as store the product information into a database for further retrieval and processing.

The process begins with a user getting project information 102 which may be a name or other descriptor. If the project is a continuation of a previous project 104, the user can fetch the product record 106 from a data storage unit. In either event the user is presented with the project 108, which may be blank for a new project. The system presents to the user a list of conforming elements 110 for the user to select. The conforming elements are appropriate items of features a user may want to select given the current project status. For example, in a new project the user may be presented with a wide variety of conforming elements because there are no limitations on the design. Whereas an existing project that specifies incandescent lamps would have conforming elements that only worked with incandescent lamps. Once the user selects an element 112, the system displays to the user 114 a visual image of the current product design [configuration] along with other descriptor information such as a product identification number. If the user is not finished 116 with the current product design, the user can reiteratively add to, modify or delete a feature or part. With each iteration the user is presented with a new list of conforming elements 110 based on the current state of the product design and presents a visual image of the current state of the design.

Once a designer is finished they may save the project 118. Whether the project is saved or not, the system presents to the user ordering information for the project which includes information on the specific configuration. This information also includes descriptor information 124 describing the product and a configuration code 126 that uniquely defines the particular design. The system allows for identifying unique customers and creating configuration codes unique to that customer, thus allowing for customer management through the life of the design. Also the descriptor information may be used for submittals for a contractor to submit to the architect for review and approval. Submittals often include such items as drawings, mechanical specifications, electrical data, warranties and other information. In the figure the distribute function 128 accesses corresponding databases and electronic communications means to provide the functions 136-150. The distribute function 128 accesses the databases based on the necessary parts or services for the product configuration. Storage of the product design in a database allows for retrievel of the design by interested users later in the design life cycle.

In the foregoing a BOM may be comprised of stock keeping units (SKU) which are identifiers used by merchants to permit the systematic tracking of products and services offered to customers. Usage of the SKU system is rooted in the drill down method, pertaining to data management. SKUs are usually assigned and serialized at the merchant level. Each SKU is attached to an item, variant, product line, bundle, service, fee, or attachment. SKUs are not always associated with actual physical items, but are more appropriately billable entities. Extended warranties, delivery fees, and installation fees are not physical, but have SKUs because they are billable.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

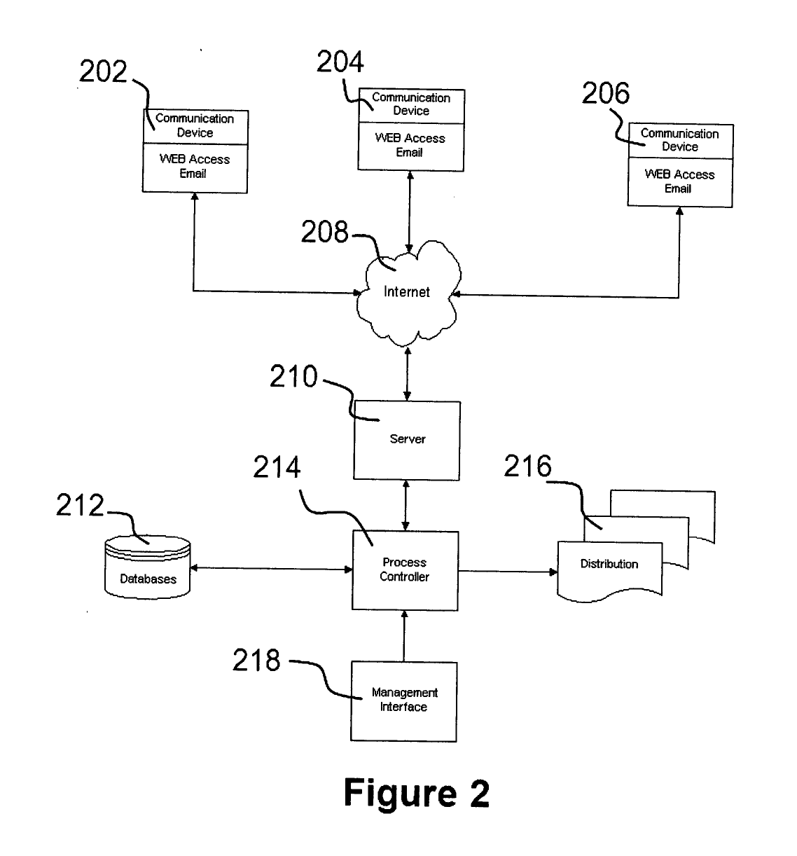

FIG. 2 shows one embodiment according to the current disclosure. In this embodiment, multiple users 202, 204 and 206 access the Internet 208 through various communication devices. The server 210, also connected to the Internet 208, is controlled by the process control 214 which is implemented in software. The process control 214 is connected to a plurality of databases 212, a management interface 218 and a distribution means 216. One having skill in the art will recognize that communicating with this embodiment may be done by a wide variety of commercially available digital communications devices, and that communicating securely using password schemes and encrypted communications is within the capabilities and may be effectuated by those skilled in the art or performed by commercially available tools such as web browsers. In addition, each user may have a unique user ID or other means to uniquely identify the user allowing for proprietary user designs.

In FIG. 2 the databases contain information about products or services that the company offers for sale. To realize the current disclosed embodiment, different products and product combinations would be established in one or more of the databases 212. The databases would contain records containing information on a particular feature. The records would provide for a visual presentation of the feature, the physical and electrical characteristics and other information as needed to effectuate the system. The process control 214 would present to the designer's communication device 202 via the server 210 and the Internet 208 a selection of parts or features. The designer would, in turn, select different features or parts until the desired lighting system is achieved. The system would then generate pricing information, installation instructions, specification sheets, ordering information, electrical drawings, conceptual drawings, manufacturing instructions, sales channel information and submittals as well as store the product information into a database for further retrieval and processing. The information generated by the current embodiment would in turn be displayed to the designer and others via the communication devices 204-206, and be made available to the manufacturer and other interested parties depending on the options set in the management interface 218.

In the current embodiment the process control 214 would allow the designer to select a particular style of luminaire. The process control 210 would then access the appropriate database to further present to the designer different parts or features (conforming elements) that would be used with the style selected. For example, if the designer selected an incandescent light, the process control would access one of the databases 212 and present to the designer via the server 210, the Internet 208 and the communications device 202 differing elements that would make up a complete incandescent light fixture or system. For example the designer may want to select differing wattage fixtures or battery emergency lighting systems. The elements selected by the designer would be configured as a single entity derived from many parts, such that the designer would not need to be concerned about which specific parts to select to create a particular light design.

Once a designer selects an initial feature, the process control 212 will only allow them to select additional elements which conform to the initial feature. For example, if a designer chooses incandescent lamps, then a fluorescent lamp fixture could not also be selected. Once the product design is created using the configuration portion of the current design, the important details about the product design can be distributed to, or accessed by, other interested parties such as contractors, sales representatives, and manufactures.

Returning to FIG. 1, in addition to letting a designer select the parts that make up the lighting system, the current disclosure shows the designer a rendition of the parts selected, either in a representation as they would look assembled or as discreet parts. A current configuration may be displayed (step 114) allowing the designer to visualize what has been selected so far, and by only presenting conforming elements (step 110), the designer would be prevented from selecting elements that are unrelated to the active design. The options for selecting conforming elements and the display options would be controlled by process control 214 together with information from the databases 212 and direction from company management 218.

One benefit of the current disclosure is the ability to let the designer try different combinations of parts and features and see how they operate and look together. Also one having skill in the art would realize that this embodiment could be implemented using standard programming tools for Internet and non-Internet applications as software for accessing databases and displaying information on the Internet are commonly used. Presently tools such as the Java programming language, SQL for accessing databases, visual languages such as VB and active server pages are widely known and this embodiment could be constructed using those tools. Table 1 shows one representative example of HTML source code that is used to generate one aspect of one embodiment of the current invention.

FIG. 1 item 132 represents a distribution means for disseminating the product or service configuration generated in steps 102 through 128, said steps detailed in following embodiments. The distribution 132 allows all the interested entities in the resulting configuration to be notified. The distribution 132 may be by electronic transmission or by storing the product configuration electronically such that interested parties have access to it through a computer network. A user implements the distribution function by selecting to store the product or service configuration in a memory. Alternatively the user may distribute the configuration through electronic mail (message) or a combination of storing the configuration in memory and sending an electronic message. In the lighting example shown above, the designer would design a unique lighting system in steps 102 through 128. Once the product design is complete, the designer can generate a specification sheet 136 to send to the customer, the contractor and other interested parties. This embodiment also supplies ordering information 138, bills of materials 140, installation instructions 142, conceptual drawings 144, manufacturing instructions 146, sales channel information 148, and electrical drawings (not shown). Ordering information 138 may be composed of combinations of existing part numbers or as a single part number and may also contain a code for user or customer information. One having skill in the art would appreciate that the distribution system and method can be expanded or reduced to include other entities and that distribution can be accomplished through various means of electronic communication including but not limited to email, web browsers, cells phones and personal digital assistants (PDAs).

In view of the foregoing, one aspect of the current disclosure is the ability to allow users to alter a configuration based on later realized requirements. For example, in the lighting system described above, after the designer creates a product design, the contractor can access the configuration and get more information or make alterations. Additionally, the sales channel has access to the information and can facilitate pricing, purchasing and manufacturing if necessary. Company management may also substitute alternative parts if desired.

This embodiment takes the product design created by a user, and together with information from the database, generates a bill of material, pricing, specifications, shipping weight, installation instructions, ordering information, submittals and conceptual images. This embodiment will also track users by specification and correlate ordering and specification information to different users. Likewise commission information can be determined allowing management to manage the sales channels and effectuate business goals. Commissions may be generated as a percent of sale or by interaction with a user to enter or adjust the amount. By storing designer information, customer information, contractor information along with a particular lighting system design, a history of the progression of the design is enabled as well as key management information for a company operating the system. For example, company management can track a design for a system from a particular designer to a particular installation.

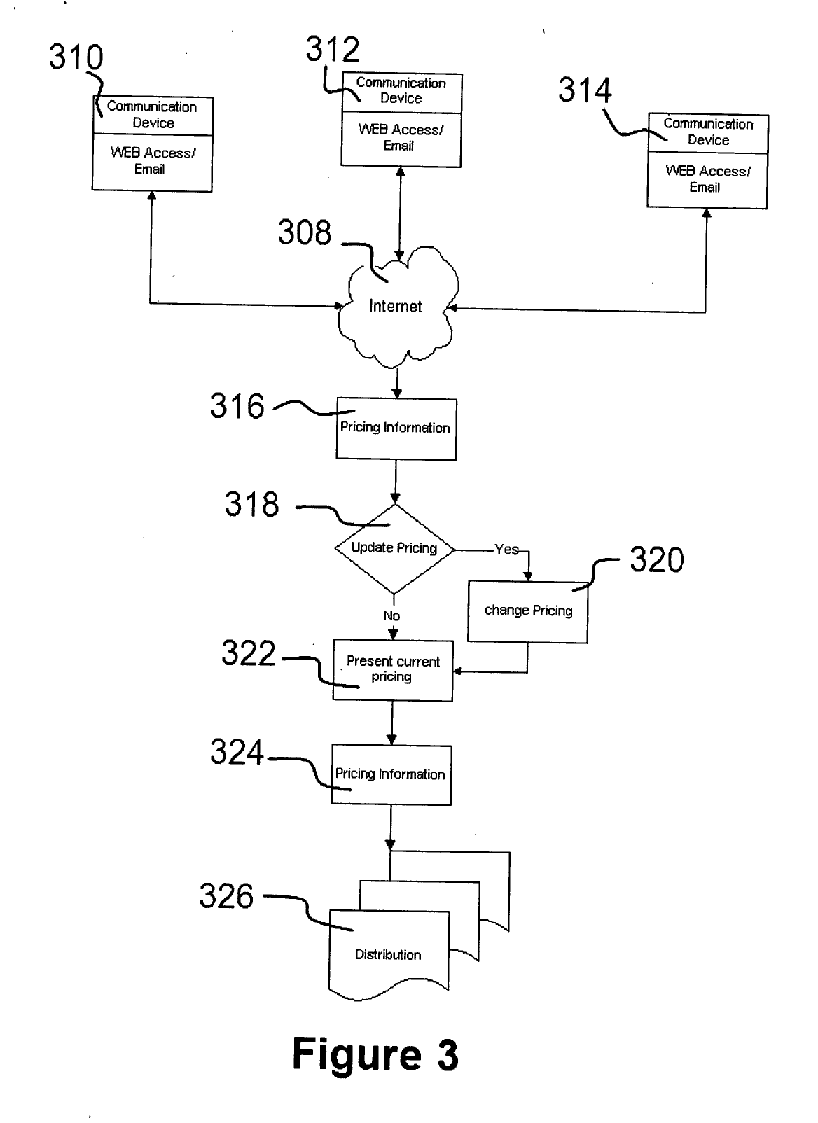

FIG. 3 shows one aspect of the current invention where one user, a sales representative for example, can access the system and determine pricing. In the lighting system example above, the designer would design the product and request a budget price. The sales representative, using a communications device 310 could use this embodiment to set or change the price (step 320), which would be communicated back to the designers or others 326. Another user, a distributor for example, can access the system and see or modify the pricing. Finally, a purchasing agent can access the system and purchase for the price indicated or communicate with the other entities involved in the system as to pricing information. Other users of the system may also have access to the pertinent price information, or through the use of a password pricing may be restricted to a narrow set of users.

FIG. 3 shows the steps involved in configuring one aspect of the current disclosure, pricing information. The same procedure for configuring pricing information could be used for other requirements, such as bills of materials or shipping weights thus allowing other interested parties to modify the underlying materials and prices of a specified product design. In the figure a user communicates to the system through the Internet 308 using a communications device 310-314. The processor delivers pricing information 316 to the user and presents the user with an option to update pricing 318. For a new configuration updating the price may require setting an initial price or changing a default price. The user may change the price 320 and will be presented the current pricing 322. The updated pricing information 324 is further distributed 326 to other interested parties. This embodiment can automatically generate bills of materials and calculate shipping weights based on the configuration entered by a user. This embodiment allows for other users to manually establish this information so that multiple users operate on the same particular product.

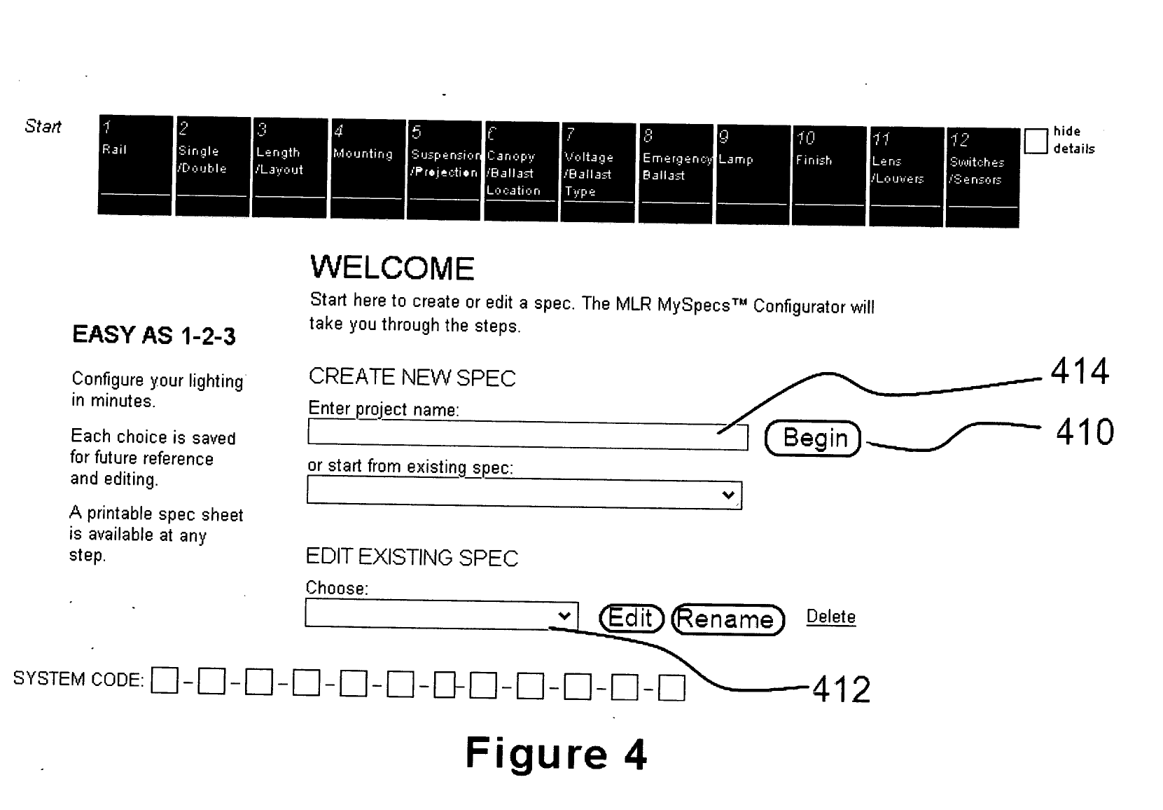

FIG. 4 shows one possible user interface according the current disclosure. This interface is embodied in a web browser and operates interactively with a user allowing product designs to be created, saved, modified or deleted A user can enter a new project name 414 and select a button 410 to walk them through the steps of creating a product or they can select an existing configuration 412 and press an “Edit” button 412 to recall a previous configuration and edit it. The steps of creating the design displayed across the top of the display providing a visual means of tracking their progress in the design stage.

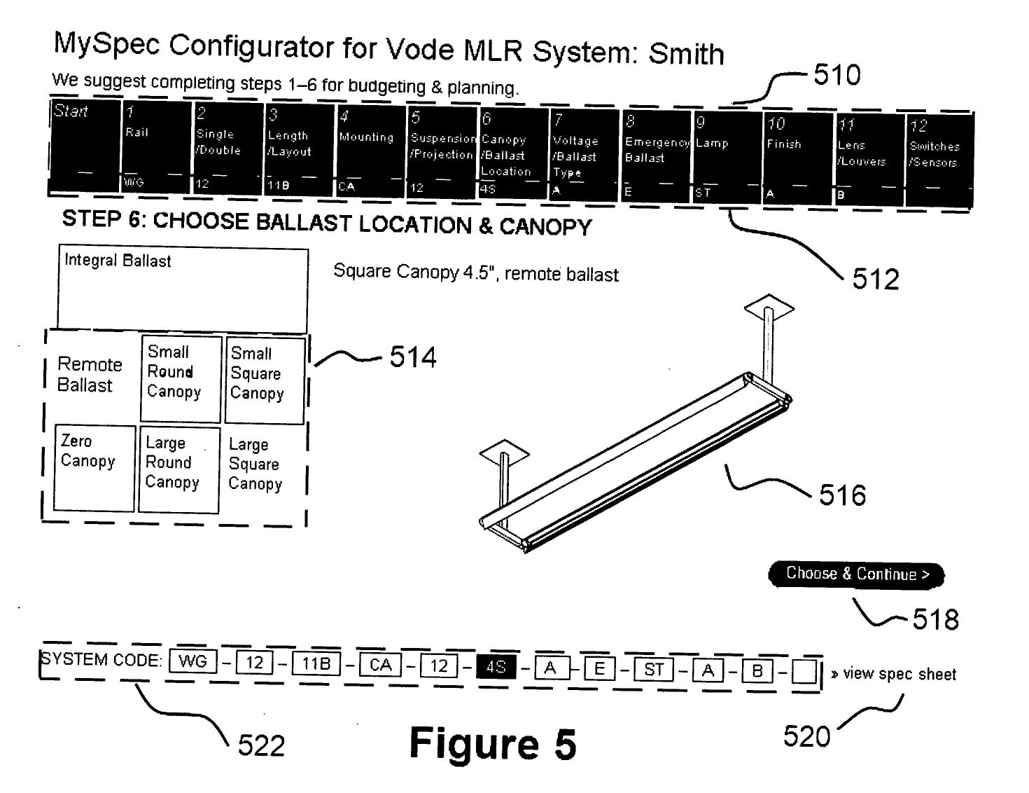

FIG. 5 shows the menu aspect of certain aspects of the invention. While the user interacts with the system, a configuration code 512 and 522 is displayed indicating a code that uniquely defines the current product design. Also for each step in the process, the selected option is displayed 510. This allows the user to see parts of the process and which options they have selected. This embodiment shows the conforming element options 514 as a menu customized for that step and showing an image of what the user has selected so far 516. The user can choose to advance to another step 518 or to view the spec sheet 520 for the product currently being configured. Item 510 shows all the possible steps in configuring the example lighting system. By selecting an option using 510 they can configure a lighting system in any order they choose or view the available options for each step.

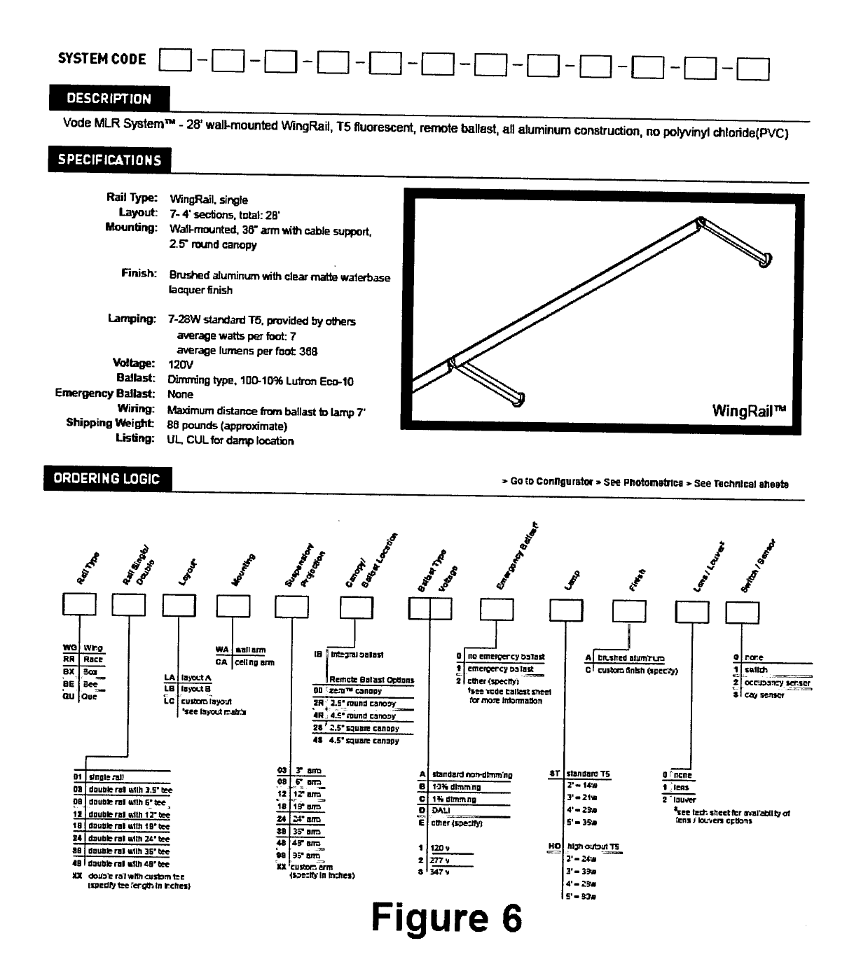

FIG. 6 is a representative sample of a specification (spec) sheet one would see in a lighting configuration. The specification sheet would be created using this embodiment and distributed to other users such as sales reps, distributors, contractors and customers. The specification sheet is generated automatically when the user selects button such as 520 in FIG. 5. Each specification sheet is unique to the current lighting system design, and may also have a unique identifier for a particular customer or designer.

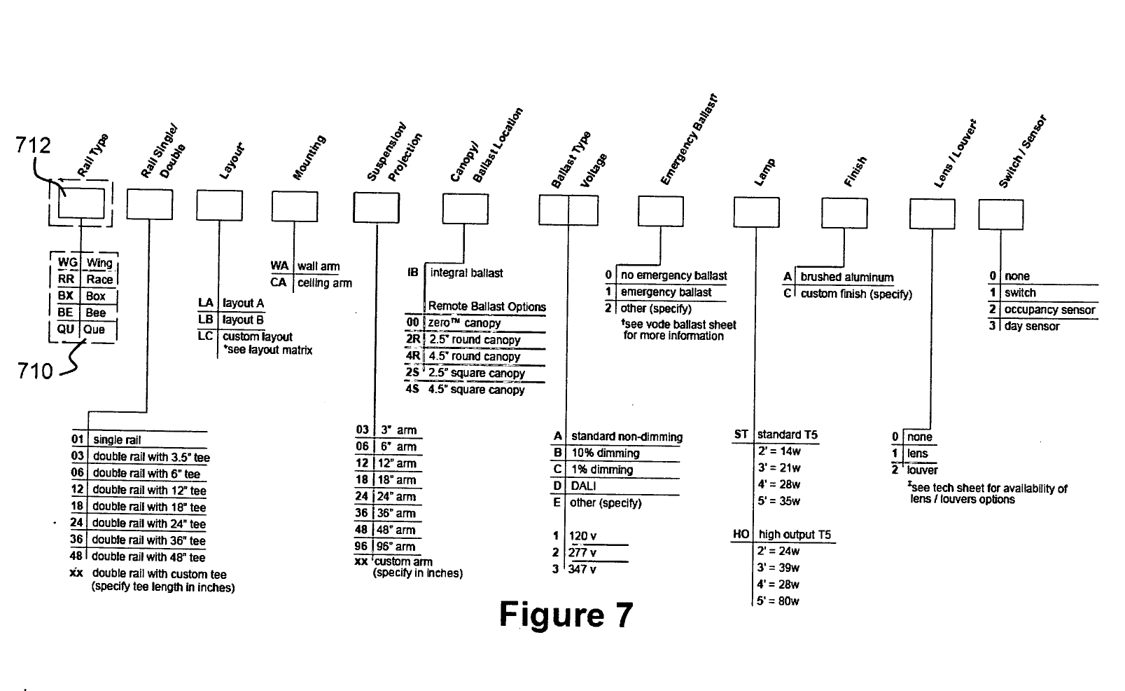

FIG. 7 shows yet another display according to the current disclosure. The browser or communications device displays an interactive representation of the configuration code. The user can interact with the configuration code, by selecting one of the options 710 presented below each possible entry 712. These can display a representation of the options for a plurality of possible configurations, and the process control 214 of FIG. 2 can modify the display based upon the input from the user such that only conforming elements are presented to the user. Once the user has entered a configuration, the process control 214 can save the configuration and provide other features as described in earlier embodiments.

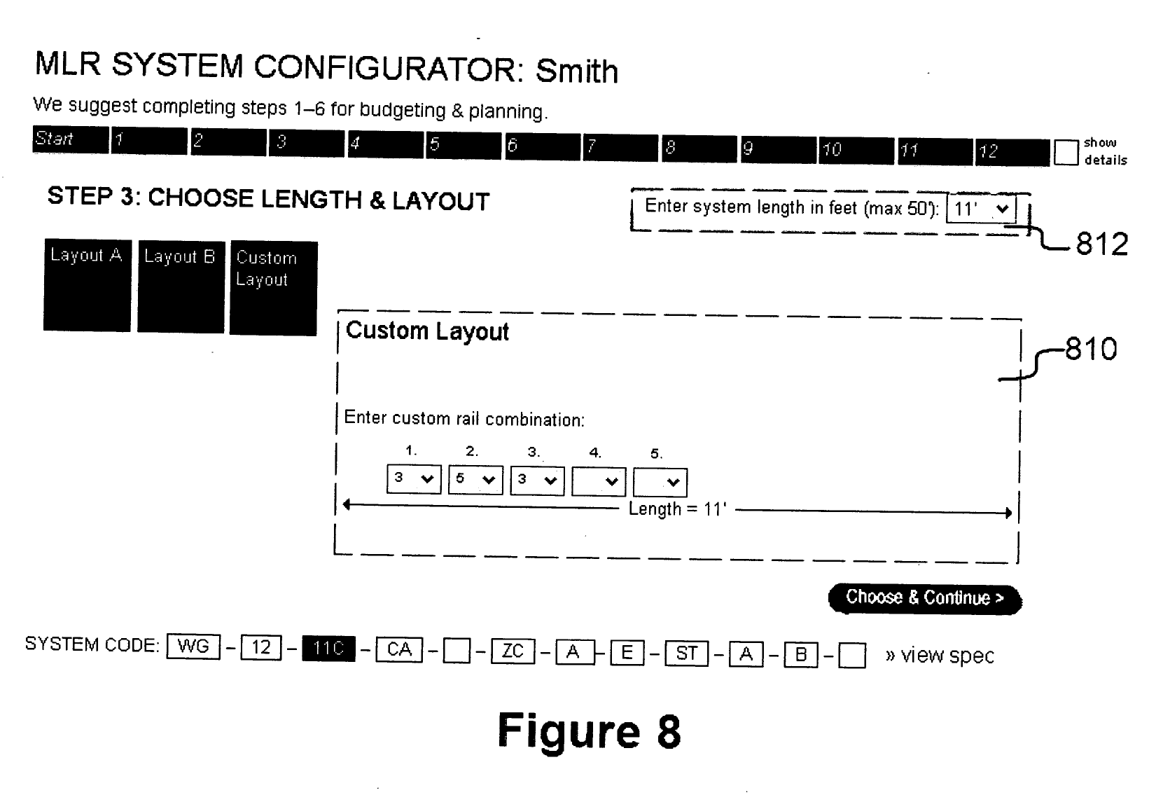

FIG. 8 shows a customization aspect according to the current disclosure. This display can be on a communications device and is shown here on embodied on a web browser. This aspect is a way for entering information for items that are not discreet parts, but are composed of multiple parts or a specific feature. As an example, item 812 allows a user to enter the length of a lighting system. Using item 810, the system allows for direct control over certain aspect of the lighting system under consideration. In the example shown on FIG. 8, the user enters 11 feet for the length of the lighting system, and item 810 allows them to specify which combinations of light rails may be used to make up 11 feet of lighting. This provides the designer with control over the final product. In this example, the users configure how many lighting sections that would make the total amount entered in item 812 and the present embodiment would provide the necessary information such as BOMs, specification sheets and other elements described in other embodiments. In practice this embodiment would allow entering lighting sections corresponding to available lamp lengths and associated hardware such as mounting and ballasting equipment.

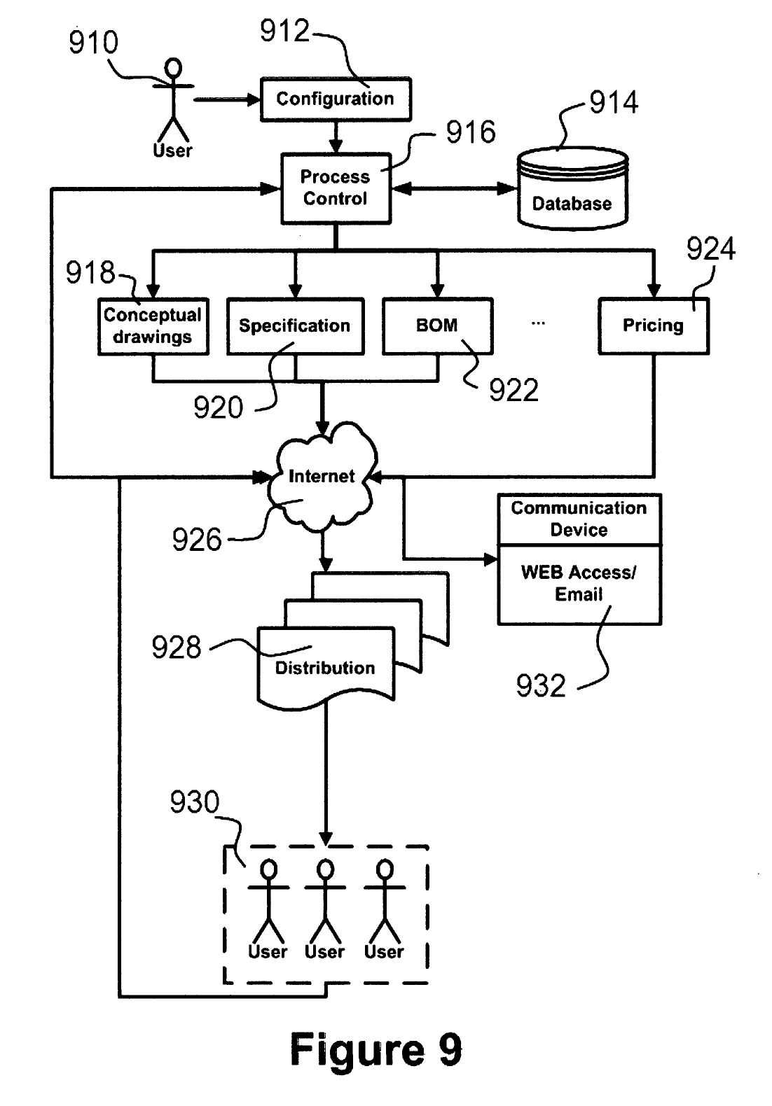

FIG. 9 is a detailed block diagram showing parts of other embodiments of the current invention. A user 910 enters a configuration 912 and the operation of the process control 916 and the database 914 provides information about the desired product design. User 910 is communicably coupled to the process control 916. The information provide by the process control 916 includes, but is not limited to conceptual drawings 918, specifications 920, bills of materials (BOMs) 922 and pricing 924. Once the process control 916 generates the information about the desired system it is made available to other users over the Internet 926, and the distribution 928 makes the information provided by the Process control 916 available to other users 930. The information provided by the process control 916 is also made available to other communications devices 932 so that users may modify the configuration or the information provided by the process control 916. The communication devices allow for multiple users to access order status, accounting information, customer management systems and e-commerce systems.

The above illustration provides many different embodiments or embodiments for implementing different features. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A computer implemented commerce system comprising:
at least one user interfaces for providing an image of a product design;
said user interface presenting at least one menu of conforming elements;
said user interface displaying at least one configuration code that relates to the product design;
a processor unit communicably coupled to the user interface and to a memory module for storage of processor instructions; and
one or more databases communicably coupled to the processor,
wherein the processor controls the user interface for providing the menu of conforming elements such that the user iteratively selects one or more conforming elements to effectuate the product design and the processor controls the user interface to present the configuration code and the image of the product design.

2. The system of claim 1 further comprising:
a distribution means for providing the product design information to one or more interested parties;
a display for a bill of materials for the product design on said user interface; and
a display for a cost of goods for the product design on said user interface,
wherein the database contains cost of goods information and bill of materials information such that the processor generates said bill of materials and cost of goods based on data in the database.

3. The system of claim 1 further comprising:
a display for price information comprising a price for the product design and one or more controls for updating the price for the product design and distributing the price to other interested parties.

4. The system of claim 1 further comprising:
a display having at least one control for generating at least one submittal for providing the product design to interested parties said submittals comprising one or more of the following: ordering information, electrical specifications, mechanical specifications, and conceptual drawings.

5. The system of claim 1 further comprising:
one or more controls for associating a user to the one or more product designs, storing the configuration code in a database and recalling the configuration code form a database.

6. The system of claim 5 wherein the configuration code comprise a unique identifier relating a product design to a customer such that a plurality of customers with the same product design will have a different configuration code.

7. The system of claim 1 wherein the product design is for a luminaire.

8. The system of claim 1 wherein the user interface is an internet browser and the processor is coupled to the user interface over the internet.

9. A computer based method of commerce comprising the following steps in any order:
presenting a menu of conforming elements such that a user selects one or more of the conforming elements to effectuate a product design;
displaying an image of the product design based on the selection of conforming elements;
altering the menu of conforming elements based on the product design;
displaying a configuration code, said configuration code based on the product design;
distributing to one or more interested parties the configuration code;
wherein a user creates the product design by selecting one or more conforming elements and is presented with an image of the product design and the configuration code.

10. The method of 9 further comprising the steps of:
generating a bill of materials for the product design based on a database relating the elements of the product design; and
generating a cost of goods for the product design based on a database containing cost information for the elements of the product design.

11. The method of claim 9 further comprising the steps of:
generating a specification sheet for the product design, and
generating a submittal for providing product information to one or more interested parties.

12. The method of claim 9 further comprising:
displaying a price for the product design;
displaying one or more controls for updating the price of the product design; and
distributing the price to other interested parties.

13. The method of claim 9 further comprising:
displaying one or more controls for associating a user to a configuration code;
storing a configuration code in a database based on the user; and
retrieving a configuration code from a database.

14. The method of claim 13 further comprising:
receiving one or more requests to view the product design based on the configuration code;
recording a history of users who request to view the product design based on a configuration code; and
displaying a history of users who request to retrieve the configuration code from a database,
wherein a record is established of users requesting the product design information.

15. One or more processor readable storage devices having processor readable code embodied on said processor readable storage devices, said processor readable code for programming one or more processors to perform a method of providing a method of commerce comprising:
presenting a menu of conforming elements such that a user selects one or more of the conforming elements to effectuate a product design;
displaying an image of the product design based on the selection of conforming elements;
altering the menu of conforming elements based on the product design;
displaying a configuration code, said configuration code based on the product design;
distributing to one or more interested parties the configuration code;
wherein a user creates the product design by selecting one or more conforming elements and is presented with an image of the product design and the configuration code.

16. The device of claim 15 wherein the method of commerce further comprises:
generating a bill of materials for the product design based on a database relating the elements of the product design;
generating a cost of goods for the product design based on a database containing cost information for the elements of the product design;
displaying a price for the product design;
displaying one or more controls for updating the price of the product design; and
distributing the price to other interested parties.

17. The device of claim 15 wherein the method of commerce further comprises:
receiving one or more requests to view the product design based on the configuration code;
recording a history of users who request to view the product design based on a configuration code, and
displaying a history of users who request to retrieve the configuration code from a database.
